(19) United States
(12) Patent Application Publication
(10) Pub. No.: US 2012/0269627 A1
(43) Pub. Date: Oct. 25, 2012

(54) VERTICAL AXIS WINDMILL SYSTEM

(76) Inventor: William Grahame, Rancho Palos Verdes, CA (US)

(21) Appl. No.: 13/092,902

(22) Filed: Apr. 22, 2011

(51) Int. Cl. F03D 7/06

(52) U.S. Cl. 416/13

(57) ABSTRACT

A vertical axis windmill system. The system includes a plurality of horizontally disposed blades attached to a vertical shaft, a windshield and a wind-flow diverter that results in increased power output of the vertical axis windmill system.

### BACKGROUND OF THE INVENTION

The present invention relates generally to windmill systems and more specifically to vertical axis windmill systems for generating mechanical and electrical energy.

Demand for windmill systems continues to increase as such windmill systems are becoming an important source of renewable energy. Increasingly, safety concerns, environmental concerns and cost concerns associated with traditional sources of energy such as nuclear and coal are causing increased demand for alternative and renewable sources of energy.

Wind turbine systems are particularly advantageous because they provide clean energy without any associated environmental pollution. Wind turbines can rotate around either a vertical or a horizontal axis to produce electrical or mechanical power.

As implied by its name, a vertical axis wind turbine rotates around a vertical axis. By rotating around a vertical axis, such wind turbines need not be pointed in the direction of the wind in order to be effective. However, relative to traditional energy sources, wind turbine systems have low efficiency and can be characterized by reduced output power.

There is a need to address one or more of the foregoing disadvantages of conventional systems and methods, and the present invention meets this need.

### BRIEF SUMMARY OF THE INVENTION

Various aspects of a vertical axis windmill system can be found in exemplary embodiments of the present invention.

In a first embodiment, the vertical axis windmill system of the present invention includes a plurality of horizontally disposed blades attached to a vertical shaft capable of rotating around a vertical axis. A flap is attachable to the trailing edge of each one of the disposed blades. The vertical axis windmill system also includes a rotatable base on which a wind-diverter and a windshield substantially located opposite the wind-diverter are mounted. The rotatable base is rotatable independent of the vertical shaft and plurality of blades.

Here, responsive to a wind stream, the rotatable base is rotated so that the windshield is positioned into the wind to prevent said wind from impinging on a portion of the plurality of blades while the wind-diverter directs wind to exposed portions of the blades that are not covered by the windshield. Among other advantages, the present invention causes increased rotation of the plurality of blades, thus resulting in higher efficiency and increased power output in accordance with the present invention.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a windmill in accordance with an exemplary embodiment of the present invention.

FIG. 2 illustrates a wind-flow controller system according to an exemplary embodiment of the present invention.

FIG. 3 illustrates a vertical axis windmill system in accordance with an exemplary embodiment of the present invention.

FIG. 4A illustrates operation of the vertical axis windmill system of FIG. 3 in accordance with an exemplary embodiment of the present invention.

FIG. 4B is a plan view of FIG. 4A illustrating operation of the vertical axis windmill system of FIG. 3.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

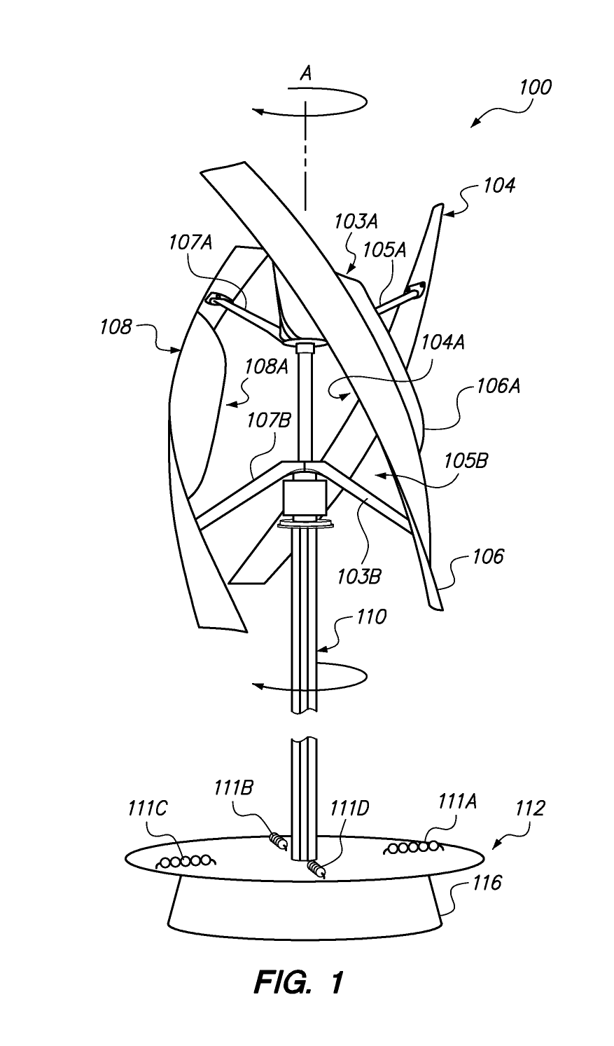

FIG. 1 illustrates windmill 100 in accordance with an exemplary embodiment of the present invention.

In FIG. 1, windmill 100 comprises a plurality of blades 104, 106 and 108 that rotate in conjunction with vertical shaft 110 when a wind stream impinges on the blades. As shown, each blade 104, 106 and 108 is curved, with an increasing curvature as the blade extends from top to bottom.

In particular, each blade 104, 106, 108 is helical, having a concave surface for receiving the impinging wind, the concave surface being maintained as the blade partially curves around vertical shaft 110 from a top to bottom direction. Although not shown, each of blades 104, 106 and 108 can be straight blades without any curvature, but it is preferred that the blades have a curvature so that the blades can rotate continuously in a clockwise direction.

Each blade 104, 106 and 108 is maintained in a substantially vertical position by using a pair of horizontal arms for attaching each blade to vertical shaft 110. Specifically, blade 104 and shaft 110 are attached via arms 105A and 105B, blade 106 and shaft 110 are attached via arms 103A and 103B and blade 108 and shaft 110 are coupled via arms 107A and 107B.

Each of said blades 104, 106 and 108 is preferably made of aluminum although any material consistent with the spirit and scope of the present invention can be utilized. Although three blades have been shown, one skilled in the art will realize that any number of blades can be used as consistent or necessary for use with the present invention.

Attached to blades 104, 106, 108 are a plurality of flaps 104A, 106A and 108A for increasing the rotational speed of the blades. Specifically, flap 104A is attached to the trailing edge of blade 104, flap 106A is attached to the trailing edge of blade 106 while flap 108A is attached to the trailing edge of blade 108.

As shown, flaps 104A, 106A and 108A increase the planform area of the blades so that more wind can impinge on the blades creating a further increase in rotational blade speed. The flaps increase the drag and lift forces of the blades causing an increase in rotational blade speed. Each flap 104A, 106A and 108A is positioned midway between the top and bottom edge of each blade while the length of each flap 104A, 106A and 108A is preferably one-half that of the blade to which it is attached. Preferably, flaps 104A, 106A and 108A and the blades are fixedly attached. Each flap is also preferably made of aluminum or other comparable materials consistent with the spirit and scope of the present invention.

As shown, the blades are attached to the upper region of vertical shaft 110, while the bottom end of vertical shaft 110 is rotatably attached to windmill base 112 so that vertical shaft 110 and the plurality of blades are rotatable with respect to windmill base 112. Windmill base 112 is preferably flat and spherical although other shapes or configurations may be utilized. Note that windmill base 112 has sufficient area to balance and support the blades particularly during blade rotation.

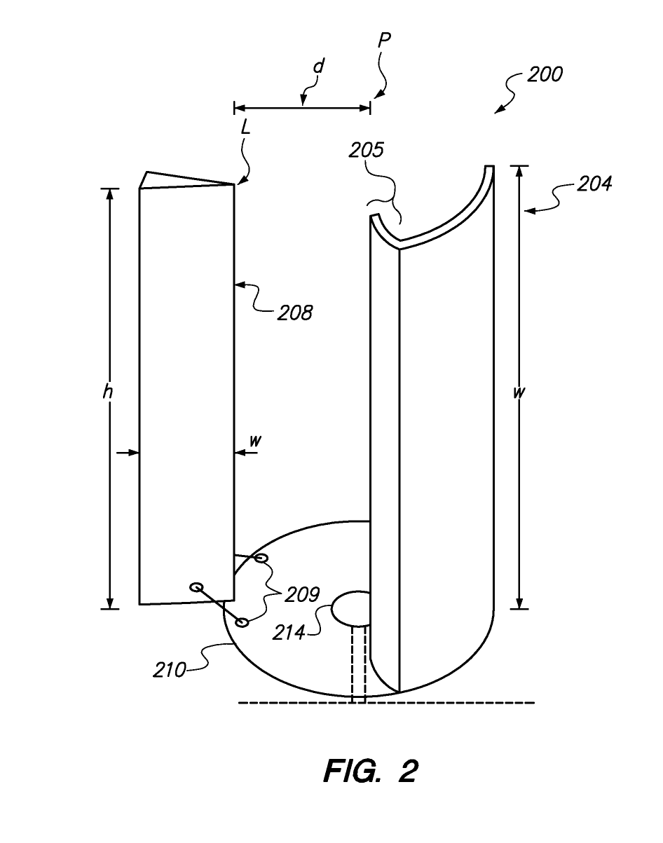

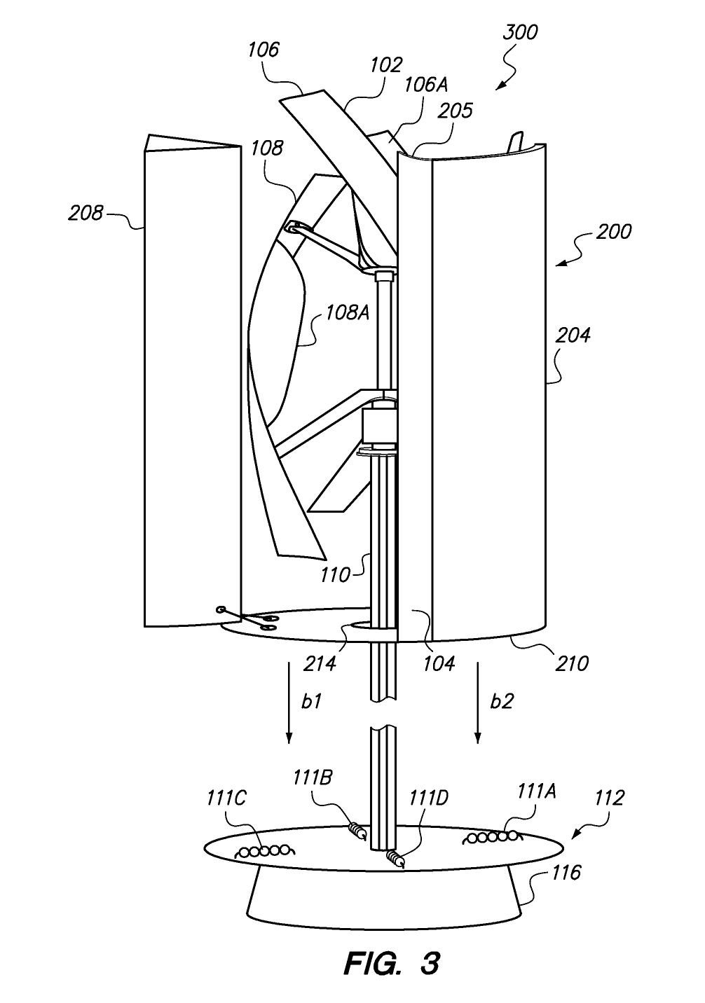

Windmill base 112 includes a plurality of roller bearings 111A, 111B, 111C and 111D as shown. It is on roller bearings 111A, B, C and D that the wind-flow controller base 210 (FIG. 2) is placed as further described with reference to FIG. 3. A pedestal support 116, providing an immovable support above which windmill base 112 resides, is also shown.

When wind impinges on blades 104, 106, 108, the entirety of windmill 100 is rotatable in a clockwise direction around a vertical axis A defined by vertical shaft 110. Specifically, blades 104, 106, 108 cause rotation of vertical shaft 110, which itself is fixedly journaled to windmill base 112. In turn, windmill base 112 is rotatable on pedestal support 116, which is itself stationary and might be comprised of metal, concrete or other like materials.

FIG. 2 illustrates wind-flow controller system 200 according to an exemplary embodiment of the present invention.

In FIG. 2, wind-flow controller 200 comprises windshield 204 and flow diverter 208 that function cooperatively to control wind received by the plurality of blades 104, 106 and 108 of FIG. 1. As shown, both windshield 204 and flow diverter 208 are attached to wind-flow controller base 210 that is preferably spherical.

As shown, windshield 204 is part of a cylindrical circumference. In particular, windshield 204 is an arcuately shaped shield that is mounted on at least a quarter of the periphery of the spherically shaped wind-flow controller base 210.

The result is that one or more or portions thereof of blades 104, 106 and 108 are prevented from engaging the wind while the exposed portions of the blades impinge the wind. Windshield 204 increases the efficiency of the vertical axis windmill system of the present invention by preventing wind from impinging on the front side of the plurality of blades, thus, only exposing active blade members to the oncoming wind.

Although windshield 204 is shown to occupy a quarter or 90 degrees of the circumference of the wind-flow controller base 210, windshield 204 may occupy more or less area depending upon the particular application of the present invention.

Windshield 204 is characterized by a height “h” that depends upon the height of blades 104, 106 and 108. Thus, height h should be sufficient to cover the vertical height of the wind-impinging blades. Windshield 204 can be made of aluminum sheets or any other comparable material.

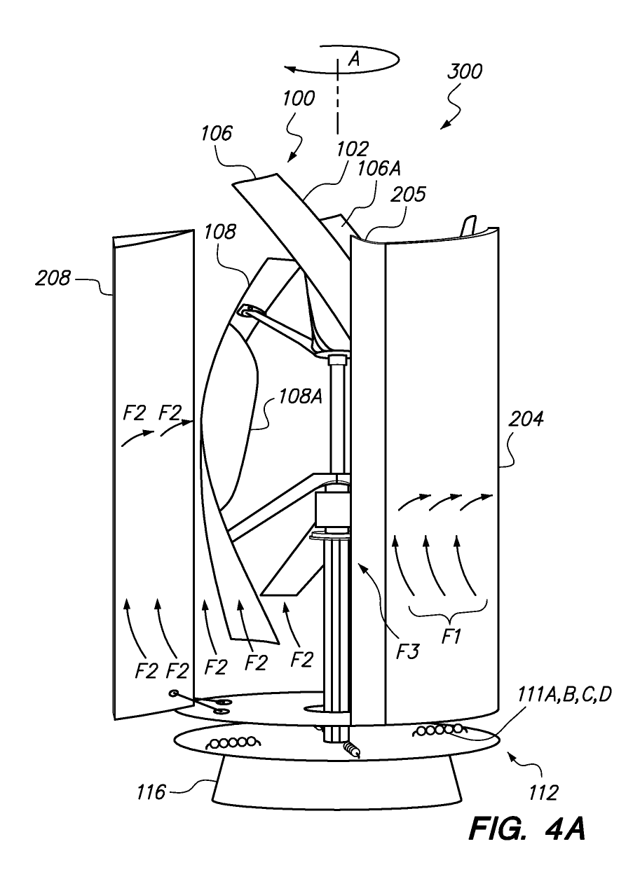

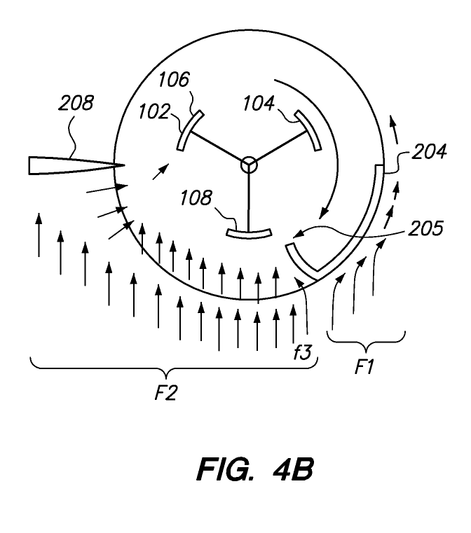

Among other advantages, windshield 204 of the present invention includes a leading edge 205 that is inwardly curved as shown. In this manner, wind directed toward leading edge 205 that would conventionally be directed away is rather directed into the blades as shown in FIG. 4B. Conventionally, without leading edge 205, wind F3 would be directed away from the blades. Here, as shown, leading edge 205 is curved inwards allowing more wind F3 to impinge on the blades. Here, the curvature of leading edge 205 depends upon the particular application.

As shown in FIG. 2, flow diverter 208 is oppositely disposed from windshield 204. Flow diverter 208 is also mounted on wind-flow controller base 210. The distance “d” between the leading edge “l” of the flow diverter 208 and a proximal end “p” of windshield 204 can vary depending upon environmental conditions and the particular application to which the present invention is to be applied, wherein “l” and “p” are selected to increase airflow to the blades.

Preferably, the height h₁ of flow diverter 208 is commensurate with the height h of windshield 204. Flow diverter 208 is mounted to wind-flow controller base 210 via a pair of couplings 209. Couplings 209 are such that the angle of the diverter can be adjusted to optimize wind flow towards the exposed blades. Moreover, flow diverter 208 can also be adjusted to be closer to either a proximal end or a distal end of windshield 204.

As implied by its name, flow diverter 208 diverts wind towards the exposed blades to increase air flow and, therefore, the rotation of the exposed blades and consequently the output power of the vertical axis windmill system.

Flow diverter 208 further serves an additional functionality in that it provides a counterbalance drag to the drag of windshield 204 particularly when wind-flow controller system 200 is in motion. Flow diverter 208 and windshield 204 are mounted on a plate which rotates on small wheels rotating on a supporting plate.

Flow diverter 208 can be made of aluminum or other suitable metals consistent with the spirit and scope of the present invention. Other such materials can be polymeric materials for example. As shown, flow diverter 208 is preferably airfoil-shaped to allow increased airflow to the plurality of blades as well as providing a counter-balance to the rotational force created by windshield 204.

In this manner, flow efficiencies towards the exposed blades are increased. Here, width “w” of flow diverter 208 is dependent upon the application to which the vertical axis windmill system is being applied. Although not shown, wind-flow controller 200 might include a plurality of flow diverters.

Wind-flow controller base 210 includes a central opening or aperture 214 that receives vertical shaft 110 of windmill 100 as further shown with reference to FIG. 3. In this manner, wind-flow controller system 200 and its windshield 204 and flow diverter 208 are connected and are rotatable about a vertical axis defined by vertical shaft 110 independent of the rotation of vertical shaft 110 and its attached blades.

FIG. 3 illustrates vertical axis windmill system 300 in accordance with an exemplary embodiment of the present invention.

In FIG. 3, specifically, windmill 100 (FIG. 1) and wind-flow controller system 200 (FIG. 2) are integrated in accordance with an exemplary embodiment of the present invention. Both systems 100 and 200 are integrated by passing vertical shaft 110 of windmill 100 through aperture 214 of the wind-flow controller system 200.

The bottom end of vertical shaft 110 is then fixedly journaled to windmill base 112, which is rotatably mounted on pedestal support 116. As previously noted, pedestal support 116 is stationary and immobile.

Wind-flow controller system 200 is then lowered (as shown by arrows b₁ and b₂) until windmill base 210 is in contact with roller bearings 111A, 111B, 111C and 111D. The entire structure is supported by pedestal support 116. In this manner, windmill 100 (windmill base 112 fixedly attached to vertical shaft 110 and plurality of blades 104, 106 and 108) is rotatable as a single unit while wind-flow controller system 200 (wind-flow controller base 210, windshield 204 and flow diverter 208) is independently rotatable independent of the rotation of windmill 100.

Roller bearings 111A, B, C, D show that both units, that is, windmill 100 and wind-flow controller system 200 can rotate independently. Use and operation of the present invention will now be illustrated with reference to FIG. 4A and FIG. 4B.

FIG. 4A illustrates operation of vertical axis windmill system 300 of FIG. 3 in accordance with an exemplary embodiment of the present invention.

In FIG. 4A, when the wind is in the direction shown by arrows F1, F2 (toward the page), higher lift and drag forces are produced by the wind stream F2 on the left side to rotate the windmill 100 in a clockwise direction.

On the right side, wind stream F1 does not impinge on the advancing blades 104, 106 and 108 that are rotating in a clockwise direction. In particular, windshield 204 obstructs wind stream F1 from reaching the right side of windmill 100 so as to prevent impingement of wind F1 on blades 104 and 106.

Without windshield 204, wind stream F1 would impinge on the advancing blades, slowing down rotation and detracting from the useful energy of the system, resulting in a highly inefficient system. Accordingly, among other advantages of the present invention, a windshield is provided on a rotatable base to obstruct the wind stream on the non-useful side of a windmill system resulting in increased power output and a more efficient windmill system.

Specifically, in FIG. 4A, wind stream F1 does not impinge on the advancing blades on the right while the wind stream F2 on the left side adds to the useful energy of windmill 100 by impinging on the left side of the blades, causing increased rotation. With less drag force, therefore, being produced on the right side, the rotational speed of the blades of windmill 100 is increased resulting in greater power output.

Another advantage is that leading edge 205 is inwardly curved permitting wind F3 to reach and impinge on the blades. Without inwardly curved leading edge 205, wind F3 would be obstructed by shield 204 from reaching the blades.

Yet, a further advantage of the present invention is that, as can be seen, the wind stream F2 impinges upon diverter 208 (flow diverter) which then diverts the wind stream towards the left portion of the blades, namely, 108 and 106, further increasing the rotational speed of the blades and consequently generating increased output power.

Although not shown, a wind vane might be attached to wind control system 200 to weathercock windshield 204 in response to the wind stream. The wind vane changes and directs the windshield 204 into the correct position when the wind's direction changes. When the wind direction changes, for example, windshield 204 may be in a different position from that shown in FIG. 2A.

In that case, windshield 204 is rotated (assisted by roller bearings 111A, B, C and D) into a new position. Meanwhile, windmill 100, having windmill base 112 rotatably attached to pedestal support 116 continues to rotate in a clockwise direction.

Any conventional weather vane consistent with the spirit and scope of the present invention can be utilized. A weather vane has been omitted for ease of illustration of the present invention. The weather vane may or may not be directly attached to the windshield 204 as in the case of direct servo motors to rotate the shield either by remote control, by use of a DC selsyn system with an amplifier to drive a reversible motor that turns the shield to the position indicated by the wind vane. Herein, note also vertical shaft 110 is also typically connected to a generator, which is not shown to simplify illustration of the present invention.

Operation of vertical axis windmill system 300 is further illustrated in FIG. 4B, which is a plan view of FIG. 4A.

In FIG. 4B, wind stream F1 is prevented from impinging on blades 104, 106 by windshield 204 while wind stream F2 can impinge on blade 108 and a portion of blade 106 for increased rotation of windmill 100 and hence increased rotational power. Diverter 208, as shown, also diverts wind stream F2 towards the blades to increase rotational speed of the blades.

A number of tests and simulations indicate that the present invention generated increases in power output of 33 to 40 percent relative to conventional vertical axis windmill systems. Two models of the vertical axis windmill configurations of the present invention are tested relative to respective conventional windmills.

The first model is a 24-bladed vertical axis windmill having a height of nine inches and a diameter of six inches. The chord of each blade is one inch. The second is a three-bladed vertical axis windmill having a height of nine inches and a diameter of five inches. The blades on this model have a one inch cord and are curved from top to bottom.

The flow diverter is ten inches in length and two and one-half (2.5) inches in width. Disposed opposite the flow diverter is a windshield that is ten inches in length and has a curved width of five inches. A 20-inch fan located approximately two feet from the windmills provided air flow at a velocity of 18.9 ft/second for wind stream simulation. An electric motor mounted on each model provided voltage (Volts) and current measurements (Amps) from which power output in Watts is determined.

Model test comparisons with and without the flow diverter provided the percentage of power improvement indicating the actual wind turbine power output. The spacing between the flow diverter and the windmill blades is one inch for all models. The results for the above are:

| | | Power |
|---|---|---|
| Model | Volts/Amps | Output |
| Conventional 24-bladed model | 0.090/35.6 | 3.2 watts |
| 24-bladed model of the present invention | 0.106/40.2 | 4.26 watts |
| Conventional three-bladed model | 0.096/38.2 | 3.66 watts |
| Three-bladed model of the present invention | 0.119/42.8 | 5.09 watts |

The test results showed an increased power output of 33 percent for the 24-bladed model and a 39.1 percent increased output for the three-bladed windmill model.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A vertical axis windmill system having a vertical shaft rotatably mounted on a support, said vertical shaft having a plurality of blades journaled thereon so that said blades are rotatable around a vertical axis defined by said vertical shaft, said vertical axis windmill system having a rotatable base mounted over said support and said rotatable base being rotatable around said vertical axis, said vertical axis windmill comprising:
a wind-flow diverter oppositely disposed to a windshield mounted on the rotatable base, said rotatable base being rotatable independent of said vertical shaft and the plurality of blades journaled thereon so that said rotatable base concurrently rotates both of the wind-flow diverter and windshield responsive to a wind such that said windshield shields at least a portion of the plurality of blades from the wind while said wind-flow diverter directs wind to exposed portions of the plurality of blades that are not shielded by the windshield.

2. The system of claim 1 wherein said wind-flow diverter provides a counter-balance drag to a drag of said windshield.

3. The system of claim 1 wherein said wind-flow diverter is mounted on the rotatable base substantially 90 degrees from a leading edge of the windshield.

4. A system having a vertical shaft rotatably mounted on a support, said vertical shaft having a plurality of blades journaled thereon so that said blades are rotatable around a vertical axis defined by said vertical shaft, said system including a rotatable base mounted over said support and said rotatable base being rotatable around said vertical axis, said vertical axis windmill comprising:
a plurality of flaps each attached to a trailing edge of each one of the plurality of blades;
a wind-flow diverter oppositely disposed to a windshield mounted on the rotatable base, said rotatable base being rotatable independent of said vertical shaft and the plurality of blades having said flaps attached thereon so that said rotatable base concurrently rotates the wind-flow diverter and windshield responsive to a wind such that said windshield shields at least a portion of the plurality of blades from the wind while said wind-flow diverter directs wind to exposed portions of the plurality of blades that are not shielded by the windshield to cause rotation of said plurality of blades and attached flaps, said flaps causing an increased rotation relative to a rotation obtained with no flaps attached to said plurality of blades.

5. The system of claim 4 wherein said wind-flow diverter provides a counter-balance drag to a drag of said windshield.

6. The system of claim 4 wherein said wind-flow diverter is mounted on the rotatable base substantially 90 degrees from a leading edge of the windshield.

7. A system having a vertical shaft rotatably mounted on a support, said vertical shaft having a plurality of blades journaled thereon so that said blades are rotatable around a vertical axis defined by said vertical shaft, said system includes a rotatable base that is rotatable around said vertical axis, said vertical axis windmill comprising:
a plurality of flaps each attached to a trailing edge of each one of the plurality of blades;
a wind-flow diverter oppositely disposed to a windshield, wherein said windshield includes a proximal edge that is concavely curved toward the vertical shaft, said wind-flow diverter and said windshield are mounted and are rotatable independent of said vertical shaft and the plurality of blades having said flaps attached thereon so that responsive to a wind said wind-flow diverter and windshield rotate together such that said windshield shields at least a portion of the plurality of blades from the wind while said wind-flow diverter directs wind to exposed portions of the plurality of blades that are not shielded by the windshield to cause rotation of said plurality of blades and attached flaps, said flaps causing an increased rotation relative to a rotation obtained with no flaps attached to said plurality of blades.

8. The system of claim 7 wherein said wind-flow diverter provides a counter-balance drag to a drag of said windshield.

9. The system of claim 7 wherein said wind-flow diverter is mounted on the rotatable base substantially 90 degrees from a leading edge of the windshield.

10. The system of claim 7 wherein said proximal edge that is curved inward permits, relative to a system with no curved proximal edge, additional wind to reach the plurality of blades.
